(19) United States
(12) Patent Application Publication
(10) Pub. No.: US 2005/0092079 A1
(43) Pub. Date: May 5, 2005

(54) Diaphragm monitoring for flow control devices

(76) Inventors: Richard A. Ales, Mentor, OH (US); William H. Glime, Painesville, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/957,832

(22) Filed: Oct. 4, 2004

Related U.S. Application Data
(60) Provisional application No. 60/549,005, filed on Mar. 1, 2004.
(60) Provisional application No. 60/481,463, filed on Oct. 3, 2003.

(51) Int. Cl. G01F 3/20

(52) U.S. Cl. 73/270

(57) ABSTRACT

Diaphragm position sensing and movement sensing for diaphragm valves is realized with one or more sensors that are directly disposed with the diaphragm or directly sense the diaphragm itself rather than an associated part of a valve. The invention contemplates many different types of sensors and also temperature compensation.

### RELATED APPLICATIONS

This application claims the benefit of the following pending U.S. Provisional patent applications, Ser. Nos. 60/549,005 filed on Mar. 1, 2004 for DIAPHRAGM VALVE MONITORING, and 60/481,463 filed on Oct. 3, 2003 for DIAPHRAGM VALVE MONITORING, the entire disclosures of which are fully incorporated herein by reference.

### TECHNICAL FIELD

The present invention relates to fluid handling systems and to flow control devices that use diaphragms and are used in such systems. The invention is especially applicable to valves and regulators used in semiconductor processing, analytical instrumentation, biopharmaceuticals, and so on in any application where accurate feedback of the diaphragm state is desirable.

### BACKGROUND OF THE INVENTION

Fluid handling systems often include diaphragm valves to regulate and control fluid flow within a system. Some fluid handling systems control flow of high purity materials or toxic materials or very expensive biopharmaceutical products, to name a few examples of the types of systems that can benefit from the teachings of the present invention. For example, in semiconductor processing, analytical instrumentation, biopharmaceuticals, and so on, accurate feedback of the valve state is desirable.

Proper feedback about the status of a diaphragm valve is important for accurate flow and process control. Valve status may include open, closed or intermediate (transient or otherwise) as referenced to the position of the diaphragm relative to an orifice that the diaphragm is used to open and close. Diaphragm position is controlled by an actuator. Known actuators may be manually operated or by operation of pneumatic, hydraulic or electric powered devices. Typically, an actuator includes a stem or plunger that contacts a non-wetted surface of the diaphragm such that movement of the stem causes a desired deflection or movement of the diaphragm to open and close the valve. The stem may be “tied” or mechanically joined to the diaphragm or may simply contact one side of the diaphragm. A pneumatic or hydraulic piston, or electromechanical plunger is typically used to cause movement of the stem. For manual valves, rotation of a handle causes movement of the actuator stem. Rotary style actuators may also be operated with pneumatics, hydraulics or electrical power.

In known diaphragm valves, one side of the diaphragm faces the actuator mechanism and is not exposed to the process fluid. This side of the diaphragm is commonly known as the “non-wetted” side or “non-process” side. The opposite side of the diaphragm physically contacts a valve seat about a flow orifice and therefore is generally referred to as the “wetted” or “process” side. In a tied diaphragm design, a stem that extends into the valve cavity on the wetted side of the diaphragm typically contacts and seals the valve seat.

In order to minimize risk of compromising the process fluid, known diaphragm valve status indicators have been based on detecting position or position changes of one or more components of the actuator. However, due to diaphragm flexure and movement, and normal tolerance stackups, the actuator position is not always a precise indicator of the diaphragm position. Particularly in diaphragm valves that do not use a tied diaphragm, the actuator stem might move and appear to be functioning normally, even though, for example, the diaphragm could be stuck in a closed position. Such anomalies can result in a loss of product.

Pressure transducers are also commonly used in the above-noted industries. Known pressure transducers may use a strain gauge attached to a process fluid barrier, including in some designs a diaphragm. Typically, the strain gauge is attached by a suitable technique such as by adhesive bonding. Pressure transducer diaphragms typically only need to deflect a few thousandths of an inch or less in response to a pressure differential above and below the diaphragm.

### SUMMARY OF THE INVENTION

The present invention is directed to methods and apparatus for detecting diaphragm position and/or movement in a diaphragm valve. The invention finds application in a wide variety of industries and is suited for high temperature (200° C. for example), high cycle and high deflection diaphragm valve applications. The invention, however, is not limited to such performance ranges and may find application at lower or higher temperatures, cycles and diaphragm deflection ranges. In accordance with one aspect of the invention, apparatus and methods are provided to measure or detect diaphragm position or movement by directly detecting the diaphragm itself, in distinct contrast to detecting a diaphragm position or movement indirectly via an actuator or other structure within the valve. The diaphragm may be single or multi-layer. In one embodiment, a strain gauge sensor is directly deposited or otherwise applied to or disposed on a surface of the diaphragm. Preferably, although not necessarily, the sensor is positioned on the non-wetted side of the diaphragm. The sensor may also be positioned between layers in a multi-layer diaphragm.

The strain gauge is intimately deposited or disposed on the diaphragm surface so as to directly and accurately detect diaphragm position and/or movement. The diaphragm valve may be used in open and closed positions or alternatively may be used to provide a metering function with the diaphragm in intermediate positions between open and closed positions.

In accordance with another aspect of the invention, a strain gauge, such as for example a resistance strain gauge, is deposited or disposed by any suitable technique on a surface of the diaphragm. In one embodiment of the invention, a resistive strain gauge is applied to a surface of the diaphragm by vapor deposition. Examples of vapor deposition that are commercially available and suitable with the invention include but are not limited to physical vapor deposition (PVD or sputtering) and chemical vapor deposition (CVD). The strain gauge or other sensor alternatively may be bonded or otherwise attached or held adjacent to the diaphragm.

In another embodiment of the invention, multiple strain gages are used. The strain gages are disposed on the diaphragm surface at differing orientations relative to the central axis of the diaphragm. As a result, when the diaphragm is deflected toward a closed position, the sensors are placed in compression and tension and thus provide output signals of differing signs. This can help to increase sensitivity of the system.

Capacitive sensors and inductive sensors are also disclosed as suitable for position sensing and pressure sensing.

In accordance with a further of the invention, a temperature sensor is deposited or disposed by any suitable technique on a surface of the diaphragm. The temperature sensing function may be complementary to or may be independent of the function provided by the strain gauge. Specifically, the sensed temperature may be used to provide electronic compensation of a pressure or position signal provided by the strain gauge sensor, to provide a more accurate indication of position or movement of the diaphragm. Alternatively, the sensed temperature may be used to provide a temperature reading that is independent of the output of the strain gauge sensor, to measure the temperature of the process alone. A temperature sensor can be used to provide feedback to a heating or cooling mechanism for the valve.

The sensors of the present invention may be used to monitor factors other than diaphragm position. For example, the sensors may be used to detect pressure and/or allow detection of imminent or early diaphragm failure (cracking) before the situation becomes a problem.

These and other aspects and advantages of the present invention will be apparent to those skilled in the art from the following description of the preferred embodiments in view of the accompanying drawings.

### BRIEF DESCRIPTION OF THE DRAWINGS

FIG. 1 is an embodiment of the invention used in a normally open valve

FIG. 2 is an embodiment of the invention used in a normally closed valve (shown in the open position);

FIG. 3 is a representative illustration of a sensor output versus diaphragm stroke;

FIG. 4 illustrates another embodiment of the invention incorporating a temperature sensor;

FIG. 5 illustrates another embodiment of the invention using a capacitive sensor;

FIG. 6 illustrates another embodiment of the invention using a capacitive proximity sensor;

FIGS. 7-9 illustrate another embodiment of the invention using multiple sensors; and

FIGS. 10-12 illustrate additional alternative embodiments using inductive sensors.

### DESCRIPTION OF EXEMPLARY EMBODIMENTS AND BEST MODE

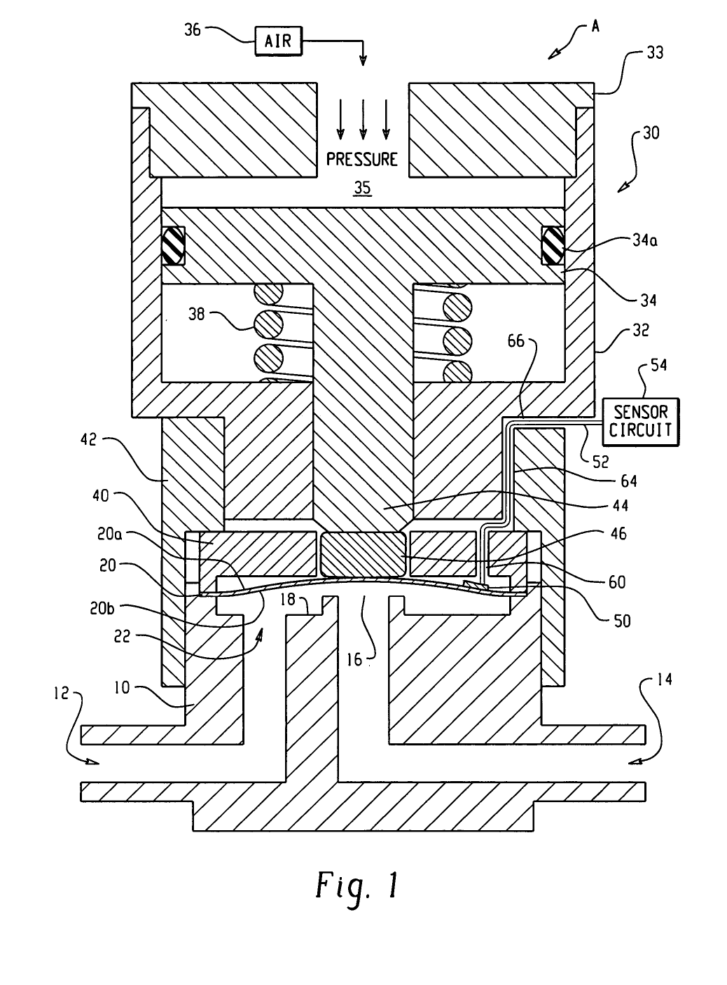

With reference to FIG. 1, an exemplary diaphragm valve that incorporates one embodiment of the invention is illustrated in longitudinal cross-section. Except for modifications to accommodate the invention, the valve is a commercially available design such as a DP Series diaphragm valve commercially available from Swagelok Company, Solon, Ohio. Suitable diaphragm valve designs are also taught in the following U.S. Pat. Nos. 6,394,417; 6,189,861; 6,123,320; and 4,671,490, the entire disclosures of which are fully incorporated herein by reference. The invention, however, will find application in any diaphragm valve design wherein a sensor can be applied to or operably coupled with a surface or other portion of the diaphragm. The invention may be used with tied diaphragm valve designs as well as non-tied diaphragm designs.

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, software, hardware, control logic and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

In the exemplary valve of FIG. 1 then, the valve assembly A includes a valve body 10 having an inlet or first flow passage 12 and an outlet or second flow passage 14. The flow passages 12, 14 include suitable fittings or other arrangements (not shown) for installing the valve assembly A into a process flow. In this valve body 10, a first orifice 16 is machined in a valve cavity surface 18 of the valve body 10. The first orifice 16 is opened or closed to fluid flow by operation of a diaphragm 20. In FIG. 1 the valve A is in an open position. When open, the first orifice 16 is in fluid communication with a second orifice 22. Either orifice 16, 22 and associated flow passage 12, 14 can serve as an inlet or outlet flow path for the valve assembly A.

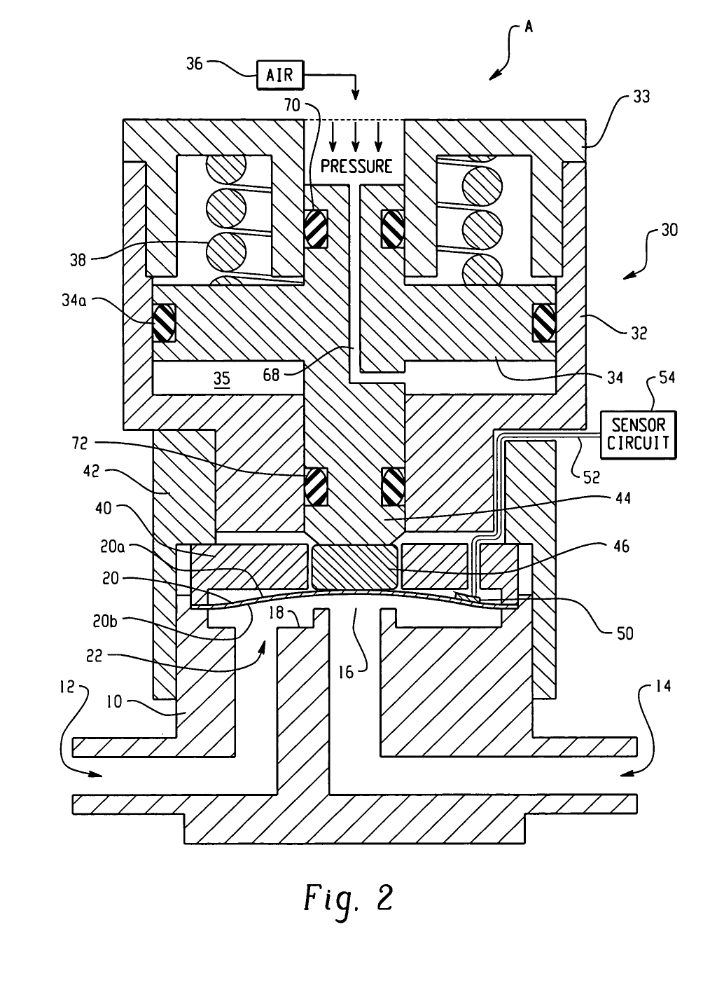

The valve assembly A includes an actuator assembly 30 for controlling movement and position of the diaphragm 20 to open and close the valve and/or regulate flow therethrough. In this example, the actuator 30 is pneumatic and includes an actuator housing 32 that slidably retains an actuator piston 34. The piston 34 may include appropriate seals 34a as required. Air pressure from a source 36 is provided through a cap 33 to an annular piston chamber 35 one side of the piston 34 using a suitable fitting (not shown). Typically, a biasing device 38 such as a spring is used to bias the valve actuator to a first position. The air pressure is used to move the actuator piston 34 to a second position (not shown) against the force of the bias. The valve of FIG. 1 is shown as a normally open valve, however, a normally closed valve may be used as is well known in the art. FIG. 2 illustrates a normally closed valve arrangement, with all other aspects of the invention as described herein being applicable to the embodiment of FIG. 2. Moreover, the actuator 30 may be pneumatic, hydraulic, electric and so on as required and is also well known in the art. The invention may also be used with manually actuated valves.

A valve bonnet 40 is used to sealingly clamp the periphery of the diaphragm 20 against the valve body. The bonnet 40 is secured to the valve body 10 by a bonnet nut 42. The bonnet nut 42 is threadably made up with the valve body 10. The actuator housing 32 may also be threadably joined to the bonnet nut 42. Other mechanisms such as bolts or weldment may be used to secure the valve assembly A together, as is well known in the art.

The valve piston 34 includes or is operably associated with an actuator stem or plunger 44. The stem 44 either contacts a non-wetted side 20a of the diaphragm that is opposite the wetted side 20b, or often a button 46 may be used. Alternatively, the actuator stem 44 may be tied to the diaphragm 20 as is known.

The valve assembly A as described thus far is old and well known to those skilled in the art, as is its operation. In order to close the valve, air pressure is introduced into the actuator housing 32 of sufficient magnitude to overcome the bias 38. This causes linear movement or translation of the piston 34 and hence the stem 44 and the button 46. Such translation of the stem 44 (downward in the view of FIG. 1) closes the valve when the diaphragm 20 seats against the cavity surface 18 around the orifice 16. Alternatively the diaphragm may seal against a surface that is part of a valve seat that is installed in the valve body. When air pressure is released to be less than the bias force of the bias member 38, the valve opens. By controlling the air pressure to intermediate values, the valve may also be used as a flow regulator.

The various valve components may be made of any material suitable for the application and compatible with the process fluid such as metal, including but not limited to stainless steel, and non-metals such as plastic.

In accordance with one aspect of the invention, a sensor 50 is disposed on a surface of the diaphragm 20. In the exemplary embodiment, the sensor 50 is disposed on the non-wetted side 20a, but alternatively may be on the wetted side 20b or between layers of a multi-layer diaphragm (not shown) or on any diaphragm surface in a multi-layer arrangement (not shown).

The sensor preferably is, though it need not be, a resistive strain gauge. Alternatively, the sensor 50 may be piezoresistive, piezoelectric, optical and so on depending on the particular application. By having the sensor 50 directly disposed on the diaphragm, the sensor 50 produces an output such as, for example a signal or exhibits a characteristic (such as resistance in this case) that changes with movement and/or position of the diaphragm 20 due to flexure or displacement of the diaphragm. A wire 52 may be used to externally access the sensor 50 output or to detect the characteristic. A sensor electronic circuit 54 is connected to the signal wire 52 so as to receive the sensor output or to detect the sensor characteristic that changes with movement of the diaphragm. For a resistive strain gauge type sensor, a Wheatstone bridge circuit may be used in a conventional manner to detect the sensor output. A wireless or optical connection may alternatively be used. The circuit 54 alternatively may be incorporated within the valve A. The circuit 54 may provide an output in any suitable form including but not limited to a visual read out and/or a wireless output signal.

As illustrated in FIG. 1, the sensor 50 is coupled to the sensor circuit 54 by any suitable technique including hardwired connections, such as the wire 52, optical connections or wireless connections. In the illustrated embodiment, the wire 52 is routed from the sensor 50 out to the circuit 54 (for those applications wherein the circuit 54 is external the valve) via suitable passageways through the valve A structure. For example, the wire 52 can extend through a bore 60 in the bonnet 40, a slot 64 through the bonnet nut 42 threads (or alternatively through a bore in the bonnet nut 42) and out a slot or bore 66 formed in the bonnet nut 42 or actuator housing 32. Other alternative techniques for routing the circuit 54 link to the sensor 50 will be available depending on the specific valve structure.

FIG. 2 illustrates a normally closed valve configuration used with the present invention. In this case, the cap 33 is modified so as to retain the spring 38 on the upper side of the piston 34, thus biasing the piston 34, and hence the diaphragm 40, to a position so as to close the valve in the absence of sufficient air pressure to overcome the spring bias. In order to introduce air into the annular piston chamber 35 on the pressurized side of the piston, a passageway 68 is formed through the piston 34. Appropriate seals 70, 72 and 34a are used to maintain a fluid tight actuation of the piston 34.

The sensor 50 thus exhibits a characteristic, in this case resistance, that changes with strain. Movement of the diaphragm, such as between open and closed positions, changes the strain across the sensor, thus producing a corresponding change in the measurable resistance of the sensor. This resistance may be detected in a known manner to ascertain the movement and/or position of the diaphragm. As noted hereinabove, other sensors may also be used including but not limited to capacitive strain gauges or optical strain gauges if so required. The invention therefore is not limited to any particular type of sensor, so long as the sensor can be directly disposed on or otherwise attached or coupled to a surface or other portion of the diaphragm 20.

In addition to sensing position and/or movement of the diaphragm, the sensor 50 may be used, for example, to count the number of diaphragm actuations and to detect gross diaphragm anomalies that interrupt the signal from the sensor 50. The sensor may also be used to sense pressure because the sensor 50 output will have a pressure signal superimposed on the basic on/of signal. The smaller variations in the sensor 50 output due to pressure variations can thus be extracted electronically to determine pressure of fluid. Still further, these variations in the sensor 50 output during operation of the diaphragm may be used to establish an initial strain profile that can be stored in memory or otherwise saved. During subsequent operation of the diaphragm, the current strain profile can be compared to the initial profile to detect changes that may indicate diaphragm wear or compromise. Thus the strain profile can be used as a end of life predictor.

A suitable sensor includes but is not limited to a thin film strain gauge, such as an encapsulated constantan foil gauge, deposited on a stainless steel diaphragm such as by sputtering. Such techniques for mounting such a sensor onto a surface of a diaphragm are commercially available from Advanced Custom Sensors, Inc., Irvine, Calif. Examples of vapor deposition that are commercially available and suitable with the invention include but are not limited to physical vapor deposition (PVD or sputtering) and chemical vapor deposition (CVD). As noted, bonded sensors and sensors attached by other techniques to the valve diaphragm may alternatively be used. The strain gauge or other sensor alternatively may be bonded or otherwise attached or held adjacent to the diaphragm.

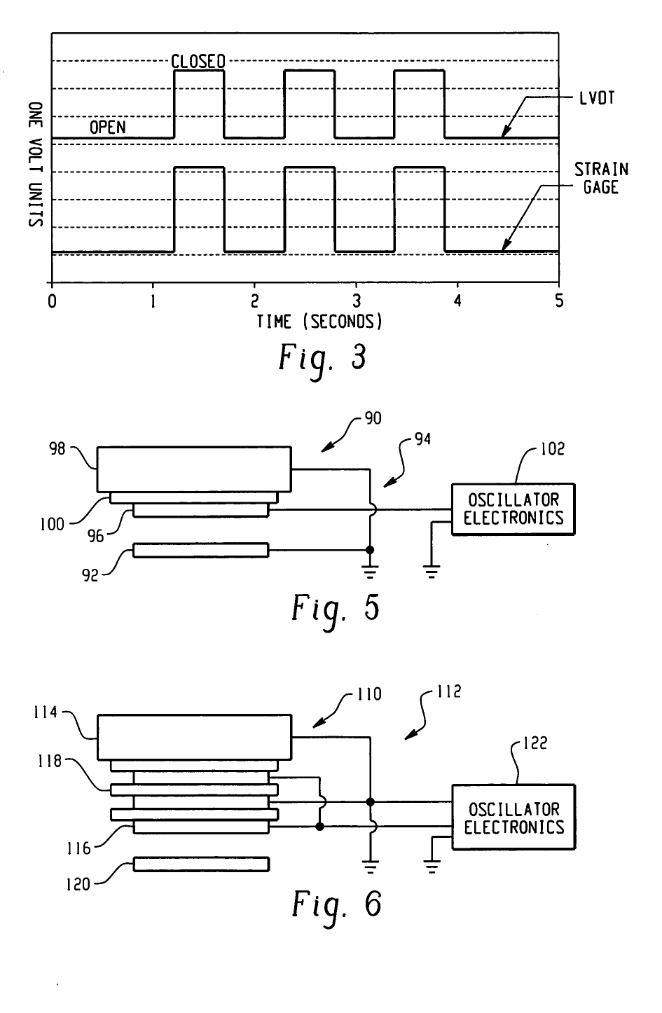

FIG. 3 is a diagrammatic illustration comparing the output of a strain gauge used for position sensing as discussed above (the lower graph in FIG. 3) with the actual diaphragm stroke as detected from the output of an LVDT that senses linear movement of the stem (the upper graph in FIG. 3). It can be seen that there is a close correlation between the two and thus the strain gauge provides an accurate representation of diaphragm position and change in position or movement.

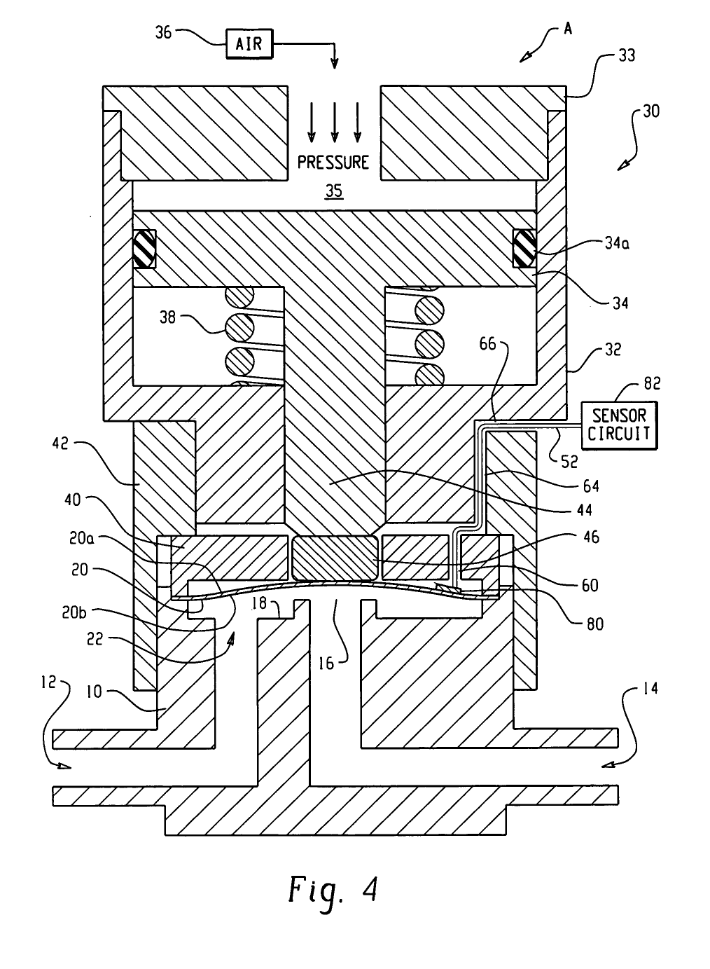

FIG. 4 illustrates another aspect of the invention in which a temperature sensor 80 is disposed on a surface of the diaphragm 20. In the exemplary embodiment, the temperature sensor 80 is disposed on the non-wetted side 20a, but alternatively may be on the wetted side 20b or between layers of a multi-layer diaphragm (not shown) or on any diaphragm surface in a multi-layer arrangement (not shown).

The temperature sensor 80 may be a platinum foil temperature sensor that is directly deposited on the diaphragm. Alternatively, the sensor 80 may be of another type depending on the particular application. The sensor 80 may be deposited using the same process as, or a process similar to, that used for deposition of the sensor 50.

By being directly disposed on the diaphragm 20, the sensor 80 produces an output such as, for example, a signal, or exhibits a characteristic, that changes with temperature of the diaphragm caused by changes in the temperature of the process fluid in the valve A or by changes in the heating or cooling that is being applied to the valve.

The sensor 80 may be deposited on the diaphragm 20 at the same time as the sensor 50, at a location close to or adjoining the sensor 50 (which is not shown in FIG. 4). Alternatively the sensor 80 may be deposited in a separate operation or at a different location than the sensor 50. As a further alternative, the structure of the sensor 80 may be incorporated into the structure of the sensor 50 to the extent that they are formed as one integrated sensor with two different architectures deposited together on the diaphragm. The same wire 52 may be used to externally access the output of the sensor 80 or to detect its characteristic; alternatively, a separate wire may be used. A sensor electronic circuit 82 is connected to the signal wire 52 (or to the separate wire) so as to receive the output of the sensor 80 or to detect the sensor characteristic that changes with temperature of the diaphragm. A wireless or optical connection may alternatively be used. The circuit 82 alternatively may be incorporated within the valve A. The circuit 82 may provide an output in any suitable form including but not limited to a visual readout and/or a wireless output signal.

The temperature sensing function that is provided by the sensor 80 may be complementary to or may be independent of the function provided by the sensor 50. Specifically, the sensed temperature may be used to provide electronic compensation of a pressure or position signal provided by the sensor 50. This can help to provide a more accurate indication of position or movement of the diaphragm 20. Alternatively, the sensed temperature may be used to provide a temperature reading that is independent of the output of the sensor 50. As an example, the temperature sensor 80 may be provided and operative even without the presence of a sensor 50, to measure the temperature of the process alone. A temperature sensor 80 can be used to provide feedback to a heating or cooling mechanism for the valve.

FIG. 5 illustrates another aspect of the invention, in which a capacitive sensor is used to sense the position of a diaphragm by measuring the change in capacitance caused by change in the distance between two conductive plates. FIG. 5 shows a capacitive sensor that is used in a diaphragm valve 90. The valve 90 may be the same as the valve shown in FIGS. 1-4 and therefore is shown only partially and schematically in FIG. 5.

In the embodiment shown in FIG. 5, the diaphragm, a portion of which is shown schematically at 92, is made from metal or is otherwise electrically conductive. The diaphragm 92 forms one plate of a variable capacitor 94. The other plate 96 is formed on a fixed portion of the valve 90, adjacent the diaphragm 92. For example, as shown in FIG. 5, the second plate 96 may be formed on the valve bonnet, a portion of which is shown schematically at 98. A layer of insulation 100 is provided between the second plate 96 and the valve bonnet 98. The two plates 92 and 96 are connected with suitable electronics 102 for providing an output signal indicative of the distance between the plates.

The diaphragm 92, as it moves within the valve 90 during valve opening and closing, moves relative to the valve bonnet 98. As this movement occurs, the distance between the diaphragm 92 and the second plate 96 changes, and so the capacitance also changes. The output signal of the sensor 94 is thus indicative of the distance between the plates 92 and 96. Because the second plate 96 is fixed in position in the valve 90, the value of the distance between the plates 92 and 96, when compared with known values for known positions, is indicative of the position of the diaphragm 92 inside the valve 90. As a result, the output of the sensor 94 is indicative of diaphragm position. The location of the second plate 96 can be optimized to most effectively determine the open, closed, and transient states of the valve.

FIG. 6 illustrates another aspect of the invention in which the position of a diaphragm is sensed or determined by measuring the change in capacitance in a capacitive proximity sensor. FIG. 6 shows a capacitive proximity sensor 110 that is used in a diaphragm valve 112. The valve 112 may be the same as the valve shown in FIGS. 1-4 and therefore is shown only partially and schematically in FIG. 6.

The capacitive proximity sensor 110 may be of the type designed by NASA the technology of which is distributed under the name Capaciflector. This type of sensor works by providing two or more electrical plates together, with a voltage differential between them, to create an electric field around the plates. The electric field extends out and around the sensor. When an object (metal or non-metallic) comes into the field, the field is disrupted, changing the capacitance in an oscillator circuit. The oscillator's amplitude is indicative of the distance between the sensor and the object.

FIG. 6 illustrates a capacitive proximity sensor 110 mounted on a valve bonnet shown schematically and partially at 114. The capacitive proximity sensor 110 includes a plurality of conductive plates or layers 116 interleaved with a plurality of insulating layers 118. Near the valve bonnet 114 is the valve diaphragm 120, which may be metallic or non-metallic. The capacitive proximity sensor 110 and the diaphragm 102 are electrically connected with suitable electronics 122.

The capacitive proximity sensor 110 is electrically driven so that its capacitive coupling field extends in the direction of the diaphragm 120. Movement of the diaphragm 120 causes a proportional change in the capacitive coupling, which results in a change in measured capacitance. The change in capacitance is indicative of the distance between the diaphragm 120 and the sensor 110. Because the sensor 110 is fixed in position in the valve 112, the value of the distance between the sensor and the diaphragm 120, when compared with known values for known positions, is indicative of the position of the diaphragm inside the valve. As a result, the output of the sensor 110 is indicative of diaphragm position. The location and number of plates in the sensor 110 can be optimized to most effectively determine the open, closed, and transient states of the valve.

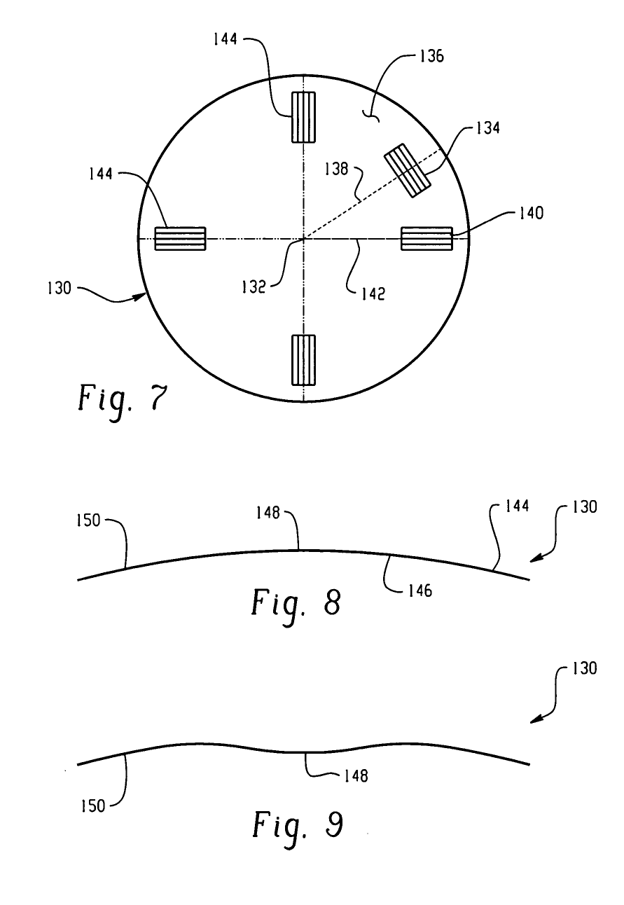

FIGS. 7-9 illustrate another embodiment of the invention. In this embodiment, multiple strain gauges, of the type discussed above with reference to FIGS. 1-3, are used on a single diaphragm. Specifically, FIG. 7 is a plan view of a diaphragm 130 that forms part of a diaphragm valve of the type discussed above with reference to FIGS. 1-3. The diaphragm 130 has in plan a circular configuration centered on an axis 132. FIG. 7 illustrates but one example of the way in which multiple strain gauges are used on a single diaphragm.

A strain gauge 134 is deposited or disposed by any suitable technique on the non-wetted surface 136 of the diaphragm 130. The strain gauge 134 is placed with its axis oriented perpendicular to a radius 138 of the diaphragm. Another strain gauge 140 is deposited or disposed by any suitable technique on the non-wetted surface 136 of the diaphragm 130. The strain gauge 140 is placed with its axis oriented parallel to a radius 142 of the diaphragm. Additional strain gauges 144 may be distributed about the diaphragm in selected orientations.

FIG. 8 is a schematic cross-sectional view of the diaphragm 130 of FIG. 7 shown in an un-deflected condition. The fluid pressure in the valve acts on the concave (wetted) surface 146 of the diaphragm 130 to place the diaphragm in the un-deflected condition shown in FIG. 8. The fluid pressure imparts a tensile strain on the diaphragm 130 at all points on the diaphragm. As a result, both the strain gauge 134, with its axis oriented perpendicular to the radius 138, and the strain gauge 140 , with its axis oriented parallel to the radius 142, will record a level of strain.

When the diaphragm 130 is deflected as shown in FIG. 9, to move the valve toward the closed condition, the central portion 148 of the diaphragm is moved downward (as viewed in FIG. 9) relative to the outer peripheral portion 150. This deflection of the diaphragm 130 produces a tensile strain in the gauge 140 that has its axis aligned with the radius 142, and simultaneously produces a compressive strain in the gauge 134 that has its axis aligned perpendicular to the radius 138.

The deflection of the diaphragm 130 thus produces strain signals of opposite sign in gauges with different orientations on the diaphragm, while all signals have the same sign when the diaphragm is un-deflected (as in FIG. 8). This feature can be used advantageously in several manners.

First, the strain signal can be refined to improve the sensitivity of the detection of diaphragm position. Different signal combinations are produced when the diaphragm is in different conditions of deflection. Specifically, a comparison of the signals from the two sensors 134 and 140 when the diaphragm 130 is pressurized and un-deflected as shown in FIG. 8 shows a relatively small difference between the signals of the two sensors. In contrast, because the two sensors 134 and 140 produce signals of opposite sign when the diaphragm is deflected, the difference between the two signals is relatively large. The magnitude of the change in this difference is significantly greater than the magnitude in the change in signal of either one sensor, alone. Thus, the system need not rely on only the magnitude of the signal from one or several gauges, when determining presence or magnitude of deflection.

Second, the use of multiple gauges can improve the ability to extract additional information (other than diaphragm position), such as the amount of fluid pressure in the valve with which the diaphragm is associated. Diaphragm deflection and strain vary with the amount of pressure, and the use of multiple gauges can help to provide a more precise measurement capability. As another example, taking readings of the amount and direction of strain on the diaphragm, at different locations on its surface, can enhance the ability to provide diagnostic information such as the presence of cracks or of localized deflection of the diaphragm. Also, the use of multiple strain gauges can impart redundancy to the system in the event of failure in a single gauge.

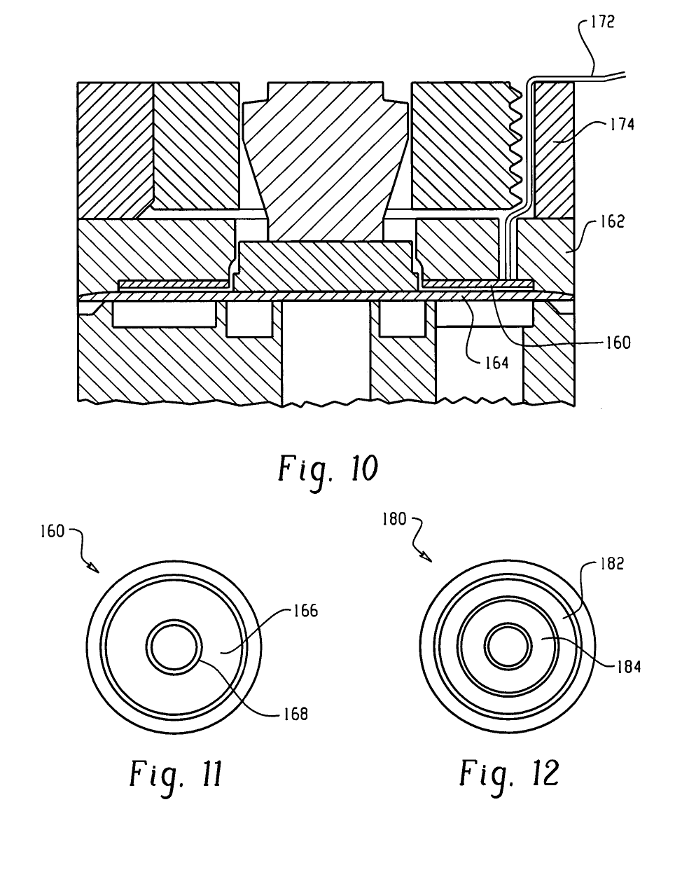

FIGS. 10-12 illustrate the use of an inductive proximity sensor to sense position and/or other aspects of a diaphragm in a diaphragm valve such as the valve 10. An inductive sensor detects metal objects by sensing the change that is induced in a magnetic field because of the presence or movement of the metal object in the magnetic field. An inductive proximity sensor incorporates an electromagnetic coil or a permanent magnet to produce a magnetic field. When a metal object enters the field, the field is disturbed. A sensing element senses this disturbance and produces an appropriate signal indicative of the presence of the object. The system including the sensor can be arranged to be triggered in response to movement of the metal object to within a certain distance of the sensor. Many different types of such sensors are commonly available and are known, for example, as inductive proximity sensors.

FIGS. 10 and 11 illustrate schematically one embodiment of the use of an inductive proximity sensor in accordance with the present invention, in association with a valve that is similar in construction to the valve 10. An inductive proximity sensor 160 is mounted on the lower side of a bonnet 162, facing a diaphragm 164. The sensor includes both a magnetic field source 166, such as an electromagnetic coil, and a sensing element 168, such as a sensing coil or a Hall effect sensor. The magnetic field source 166 projects a magnetic field onto the diaphragm 164, which is made from metal or is at least partially metallic. The diaphragm 164 and the sensing element 168 are electrically connected with suitable oscillator electronics (not shown) through a wire 172 passing through the bonnet 162 and the bonnet nut 174. Alternatively, the output of the sensor 160 can be directed out of the valve via an RF signal.

As the diaphragm 164 moves closer to or farther from the magnetic field source 166, the strength of the magnetic field at the sensing element 168 changes. The sensor 160 senses this change, either directly by sensing the change in magnetic field strength in the sensing element 168, or indirectly as the change in a measurable electrical parameter of the magnetic field source 166. The output of the sensor 160 thus represents movement or position of the diaphragm.

FIG. 12 illustrates schematically an alternative embodiment of the use of an inductive proximity sensor in accordance with the present invention. The inductive proximity sensor 180 shown in FIG. 12 includes a magnetic field source 182 and a sensing element 184 that are separate from each other rather than being one unit. Operation of the sensor 180 is similar to operation of the sensor 160 described above with respect to FIGS. 11 and 12.

A plurality of inductive sensors can be associated with one diaphragm. The number and location of the sensors can be optimized to most effectively determine the open, closed, and transient states of the valve as reflected in diaphragm position or deflection. In addition to monitoring valve status, an inductive sensor can be used to detect pressure and or allow detection of imminent or early diaphragm compromise.

The invention has been described with reference to the preferred embodiment. Modifications and alterations will occur to others upon a reading and understanding of this specification and drawings. The invention is intended to include all such modifications and alterations insofar as they come within the scope of the appended claims or the equivalents thereof.

1. A flow control device, comprising:
a diaphragm that is movable to control flow through the flow control device; and
a sensor disposed on the diaphragm, said sensor detecting movement of the diaphragm.

2. The device of claim 1 wherein said sensor comprises a strain gauge.

3. The device of claim 1 wherein the device comprises an actuator for moving the diaphragm.

4. The device of claim 1 comprising a temperature sensor disposed on the diaphragm.

5. The device of claim 1 wherein said sensor is disposed on a surface of the diaphragm.

6. The device of claim 5 wherein said sensor is deposited on a surface of the diaphragm.

7. The device of claim 5 wherein said sensor is disposed on a non-wetted side of the diaphragm.

8. The device of claim 1 wherein the device comprises a valve.

9. The device of claim 1 wherein the device comprises a flow regulator.

10. The device of claim 1 wherein said diaphragm is a multi-layer diaphragm.

11. The device of claim 1 wherein said sensor produces an output that corresponds position of the diaphragm.

12. The device of claim 1 wherein said sensor produces an output that indicates diaphragm strain and when compared to an initial strain profile can be used to predict end of life for the diaphragm.

13. The device of claim 1 comprising at least two sensors disposed on the diaphragm, each sensor being disposed at a respective angle relative to a reference.

14. A method for detecting diaphragm performance in a flow control device of the type that uses a diaphragm for flow control of a fluid through the device, comprising the steps of:
disposing a sensor on the diaphragm;
producing a sensor output that corresponds to movement or position of the diaphragm.

15. The method of claim 14 comprising the step of using the sensor to detect strain.

16. The method of claim 15 comprising the steps of:
using the sensor to produce an initial strain profile of the diaphragm;
suing the sensor to produce subsequent strain profiles of the diaphragm; and
comparing a subsequent stain profile to the initial or prior profiles to analyze diaphragm condition.

17. In combination, a diaphragm that can be installed into a flow control device to control flow of fluid through the device, and a sensor disposed on the diaphragm.

18. The assembly of claim 17 wherein said sensor comprises a strain gauge.

19. The assembly of claim 17 wherein said sensor is disposed on a surface of the diaphragm.

20. The assembly of claim 17 wherein the sensor produces an output that corresponds to movement or position of the diaphragm when used in a flow control device.

21. The assembly of claim 17 comprising a temperature sensor disposed on the diaphragm.

22. The assembly of claim 17 wherein said sensor comprises a strain gauge and a temperature sensor is also disposed on said diaphragm.

23. A flow control device, comprising:
a diaphragm that is movable to control flow through the flow control device; and
a portion of the flow control device that is fixed relative to the diaphragm to form a capacitor.

24. The device of claim 23 wherein the diaphragm and the portion that is fixed relative to the diaphragm are connected with suitable electronics for providing an output signal indicative of the distance between the diaphragm and the portion that is fixed relative to the diaphragm.

25. The device of claim 23 wherein the portion that is fixed relative to the diaphragm is positioned on a fixed portion of the device.

26. The device of claim 23 wherein the device comprises an actuator for moving the diaphragm.

27. The device of claim 23 wherein the device comprises a valve.

28. The device of clam 27 wherein the portion that is fixed relative to the diaphragm is formed on a valve bonnet.

29. The device of claim 23 further comprising an insulation layer adjacent to the portion that is fixed relative to the diaphragm.

30. The device of claim 23 wherein the device comprises a flow regulator.

31. The device of claim 23 wherein the diaphragm is a multi-layer diaphragm.

32. A method for detecting diaphragm performance in flow control device of the type tat uses a diaphragm for flow control of a fluid through the device, comprising the steps of:
creating a capacitance between the diaphragm and a portion on the flow control device;
detecting the change in capacitance that corresponds to movement of the diaphragm.

33. A flow control device, comprising:
a diaphragm that is movable to control flow through the flow control device; and
a sensor that creates a capacitive coupling field, wherein movement of the diaphragm disrupts the capacitive coupling field.

34. The device of claim 33 wherein the disruption of the capacitive coupling field results in a change in capacitance indicative of the distance between the diaphragm and the sensor.

35. The device of claim 33 wherein the device comprises an actuator for moving the diaphragm.

36. The device of claim 33 wherein the device comprises a valve.

37. The device of claim 36 wherein the sensor is fixed in position in the valve.

38. The device of claim 33 wherein the sensor includes a plurality of conductive layers interleaved with a plurality of insulating layers.

39. The device of claim 33 wherein the device comprises a flow regulator.

40. The device of claim 33 wherein the diaphragm is a multi-layer diaphragm.

41. The device of claim 33 wherein the diaphragm is non-metallic.

42. A method for detecting diaphragm performance in flow control device of the type that uses a diaphragm for flow control of a fluid through the device, comprising the steps of:
creating a capacitive coupling field that movement of the diaphragm will disrupt; and
producing a sensor output that corresponds to the disruption in the capacitive coupling field.
